(19) United States
(12) Patent Application Publication
(10) Pub. No.: US 2010/0242424 A1
(43) Pub. Date: Sep. 30, 2010

(54) HONEYCOMB FILTER

(75) Inventors: Masashi Harada, Nagoya-City (JP); Yasushi Noguchi, Nagoya-City (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 12/713,227

(22) Filed: Feb. 26, 2010

(30) Foreign Application Priority Data
Mar. 26, 2009 (JP) 2009-076130

(51) Int. Cl. B01D 35/04

(52) U.S. Cl. 55/486

(57) ABSTRACT

There is disclosed a honeycomb filter which can perform an NOₓ reduction treatment while increasing a strength and collecting a PM with a small pressure drop. The honeycomb filter includes porous partition walls which partition a plurality of cells as through channels for a fluid, and predetermined cells each having one end opened and the other end plugged and the remaining cells each having one end plugged and the other end opened are alternately arranged. In the honeycomb filter, surface layers of the partition walls on the side of the predetermined cells are coated with films containing zeolite as a main component.

### BACKGROUND OF THE INVENTION

1. Field of the Invention

The present invention relates to a honeycomb filter which collects a particle matter in an exhaust gas.

2. Description of the Related Art

As a technology for treating NOₓ included in a car exhaust gas, heretofore a three way catalyst (TWC) has broadly been used. However, the three way catalyst has a problem of an NOₓ reduction performance which is low at a low temperature. Especially, in a diesel car, the temperature of the exhaust gas is lower as compared with a gasoline car, and hence it becomes difficult to perform an NOₓ reduction treatment in a TWC system.

To solve the problem, a product for diesel cars is being developed in which zeolite is loaded in a honeycomb support member to more efficiently reduce NOₓ. A reason for the use of zeolite is that ammonia is easily adsorbed at a low temperature. Ammonia decomposes NOₓ by reactions (1) to (3) as follows. In this system, oxides such as NOₓ are selectively reduced even in an oxygen atmosphere, and hence the system is called selective catalytic reduction (SCR). Ammonia has not only properties of selectively reducing NOₓ even in an oxidizing atmosphere but also properties of conversely increasing a reaction speed owing to the coexistence of O₂.

As a measure for realizing this system, a system is suggested in which inexpensive and safe urea is used as a starting material, because it is difficult to directly add NH₃ to the exhaust gas. NOₓ (NO, NO₂) is reduced by using ammonia decomposed/formed from urea, and hence the system is especially called urea-SCR (see Non-Patent Documents 1 and 2).

4NH₃+4NO+O₂→4N₂+6H₂O (1)

2NH₃+NO+NO₂→2N₂+3H₂O (2)

8NH₃+6NO₂→7N₂+12H₂O (3)

[Non-Patent Document 1] “Science and Engineering of Zeolite” edited by Yoshio Ono, Tateaki Yashima (KODANSHA Scientific)

[Non-Patent Document 2] “Recent Development of Zeolite Catalysts” supervised by Takashi Tatsumi, Youichi Nishimura (CMC Publishing CO., LTD.)

In a case where the SCR system is mounted in the diesel car, there is a method in which, as shown in FIG. 6, the SCR and a diesel particulate filter (DPF) are arranged in series not only to reduce NOₓ but also to remove a particle matter (PM) in the exhaust gas.

Furthermore, down-sizing is requested, and hence from now on, it is demanded that SCR (an NOₓ reducing function) and DPF (a PM collecting function) are integrated (an NOₓ treatment DPF; see FIG. 7) and that the functions of NOₓ reduction and PM collection are performed by one carrier. To realize this function, zeolite is loaded onto a DPF base material, but the DPF is demanded to have a tissue with a high porosity (60% or more) in order to keep the pressure drop of the DPF coated with zeolite.

However, a structure having the tissue with the high porosity usually has a low strength, and hence has a problem that crack, cut or the like occurs in the inside or the surface of the structure owing to a difference between internal and external temperatures due to a heat treatment in a zeolite coating process.

### SUMMARY OF THE INVENTION

As a result of intensive investigation for solving the above problems of the conventional technology, the present inventor has found that the above problems can be solved by the following honeycomb filter, and has completed the present invention. That is, according to the present invention, a honeycomb filter is provided as follows. According to the present invention, there is provided a honeycomb filter having a high strength and capable of performing an NOₓ reduction treatment while collecting a PM with a small pressure drop in a case where SCR and DPF are integrated.

[1] A honeycomb filter comprising: porous partition walls which partition a plurality of cells as through channels for a fluid; predetermined cells each having one end opened and the other end plugged; and the remaining cells each having one end plugged and the other end opened, the predetermined cells and the remaining cells being alternately arranged, wherein surface layers of the partition walls on the side of the predetermined cells are coated with films containing zeolite as a main component.

[2] The honeycomb filter according to [1], wherein the partition walls contain at least one selected from the group consisting of cordierite (Cd), SiC and aluminum titanate (AT).

[3] The honeycomb filter according to [1] or [2], wherein the partition walls have median diameters of 3 μm or more and 60 μm or less and porosities of 30% or more and 60% or less.

[4] The honeycomb filter according to any one of [1] to [3], wherein the average area of the cross sections of one cell vertical to the longitudinal direction of the cell plugged in the inflow end faces is not more than that of the cross sections of the cell vertical to the longitudinal direction of the cell plugged in the outflow end faces.

[5] The honeycomb filter according to any one of [1] to [4], wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

[6] The honeycomb filter according to any one of [1] to [5], wherein the thicknesses of the films containing zeolite as the main component are 0.5% or more and 200% or less of those of the partition walls.

[7] The honeycomb filter according to any one of [1] to [6], wherein zeolite of the films containing zeolite as the main component contains at least one selected from the group consisting of ZSM-5, β-zeolite, mordenite, ferrielite, A-type zeolite, X-type zeolite and Y-type zeolite.

[8] The honeycomb filter according to any one of [1] to [7], wherein an SiO₂/Al₂O₃ ratio of zeolite constituting the films containing zeolite as the main component is 1 or more and 500 or less.

[9] The honeycomb filter according to any one of [1] to [8], wherein the films containing zeolite as the main component contain at least one selected from the group consisting of titanium, vanadium, chromium, manganese, iron, cobalt, nickel, copper, rhodium, palladium, silver and platinum.

The honeycomb filter according to the present invention has a high strength, and can perform an NOₓ reduction treatment while collecting a PM with a small pressure drop.

### BRIEF DESCRIPTION OF THE DRAWINGS

FIG. 1 is a diagram schematically showing a honeycomb filter according to one embodiment of the present invention, and a front view of the honeycomb filter;

FIG. 2 is a diagram schematically showing the honeycomb filter according to the embodiment of the present invention, and a transverse sectional view of the honeycomb filter;

FIG. 3 is a partially sectional view showing an enlarged part Q of FIG. 2 excluding the other part;

FIG. 4 is a diagram schematically showing a honeycomb filter according to another embodiment of the present invention, and a partially enlarged front view of the inflow end face of the honeycomb filter;

FIG. 5 is a graph showing the result of the evaluation of the pressure drop during the deposition of soot in a honeycomb filter of Example 1;

FIG. 6 is a side view schematically showing a honeycomb filter system in which SCR and DPF are arranged in series; and

FIG. 7 is a side view schematically showing an NOₓ treatment DPF.

### DESCRIPTION OF THE PREFERRED EMBODIMENT

Hereinafter, embodiments of the present invention will appropriately be described with reference to the drawings, but the present invention should not be limited to these embodiments when interpreted. Various alterations, modifications, improvements and replacements may be added based on the knowledge of a person with ordinary skill without impairing the scope of the present invention. For example, drawings show the preferable embodiments of the present invention, but the present invention is not restricted by the configuration or information shown in the drawings. When the present invention is carried out or verified, means similar or equivalent to that described in the present description can be applied, but appropriate means is the means described as follows.

(Honeycomb Filter)

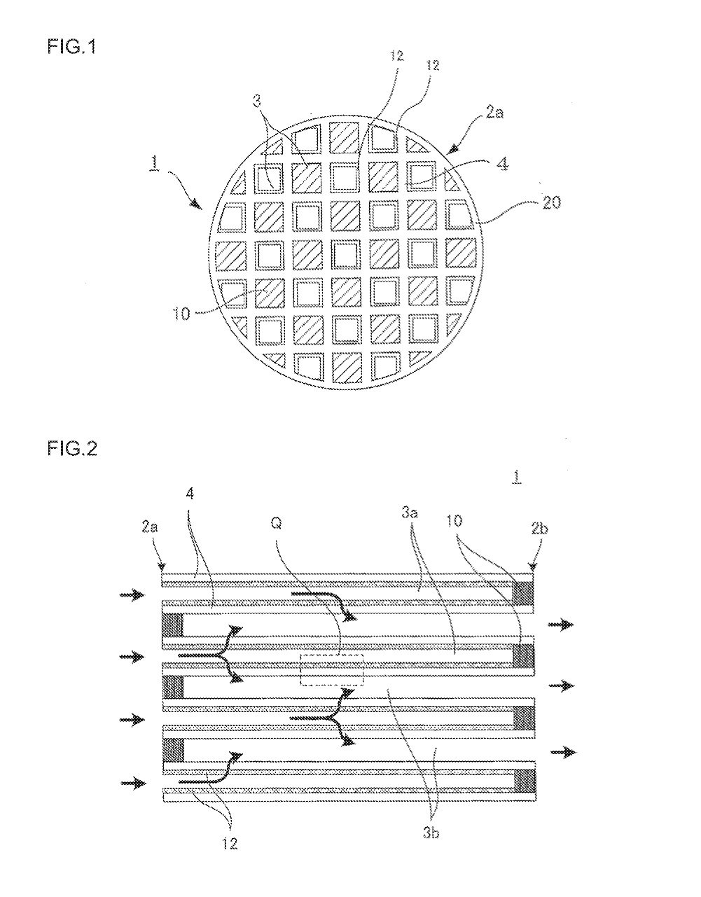

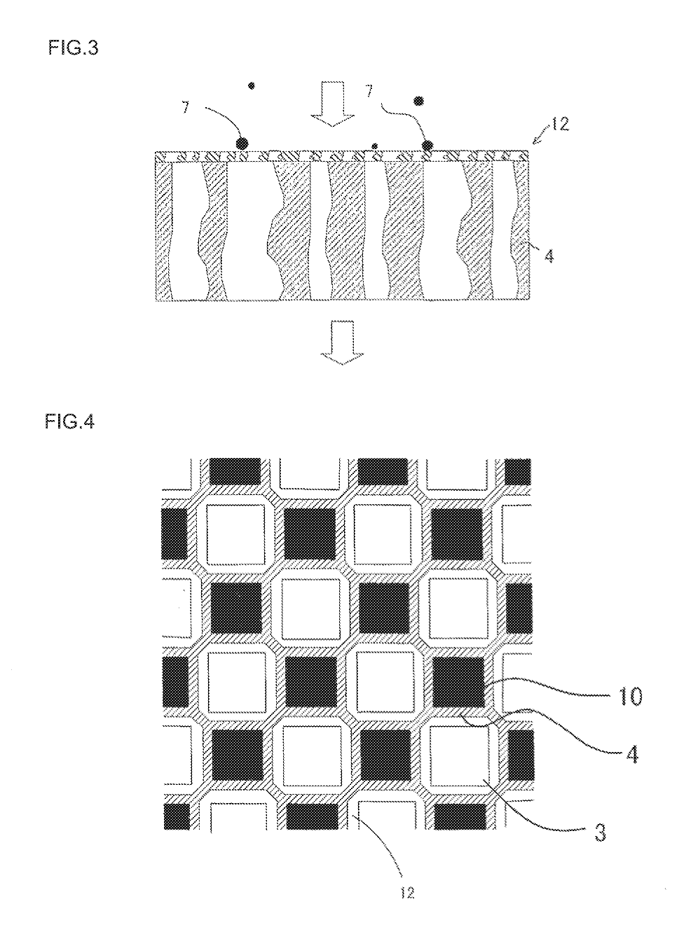

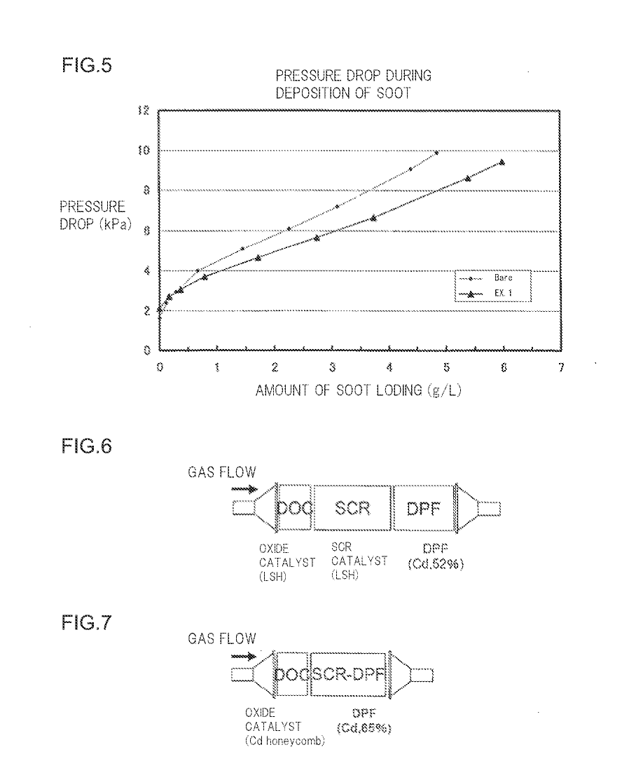

FIG. 1 is a diagram schematically showing one embodiment of a honeycomb filter according to the present invention, and a front view of the honeycomb filter. FIG. 2 is a diagram schematically showing the embodiment of the honeycomb filter according to the present invention, and a sectional view of the honeycomb filter. FIG. 3 is a partially sectional view showing an enlarged part Q of FIG. 2 excluding the other part.

In a honeycomb filter 1 shown in FIGS. 1 to 3, a main constituent element is a honeycomb structure including porous partition walls 4 which partition a plurality of cells 3 as through channels for a fluid in the inside surrounded by an outer peripheral wall 20. In this honeycomb structure, plugging portions 10 are formed which plug the ends of the cells 3. Moreover, the surfaces of the partition walls of this honeycomb structure on the side of exhaust gas inflow cells 3a are coated with films (coat layers) 12 containing zeolite as a main component, to form the honeycomb filter 1.

The material of the partition walls 4 (i.e., the material of the honeycomb structure constituting the honeycomb filter 1) preferably contains at least one selected from the group consisting of cordierite (Cd), silicon carbide (SiC; Si may be included together with silicon carbide) and aluminum titanate (AT). Moreover, the partition walls 4 may be made of at least one selected from the group consisting of cordierite (Cd), silicon carbide (SiC; Si may be included together with silicon carbide) and aluminum titanate (AT).

The honeycomb filter 1 according to the present invention is provided with the plugging portions 10 for plugging the cells 3. As the material of the plugging portions 10, for example, at least one material selected from the above examples of the material of the partition walls may be used.

The porosities of the partition walls 4 of the honeycomb filter 1 are preferably from 30 to 60%. If the porosities are over 60%, strength tends to become insufficient. Moreover, if the porosities are less than 30%, an initial (without any soot) pressure drop is large in a case where the filter is used as a DPF, and the porosities tend to be unpractical.

The median diameters of the partition walls 4 of the honeycomb filter 1 are preferably 3 μm or more and 60 μm or less. It depends on the porosities, but if the median diameters are less than 3 μm, there is a tendency that a zeolite containing slurry is not easily sucked in a case where zeolite is sucked during the formation of the films. Moreover, if pore diameters are larger than 60 μm, pores are closed with the component of zeolite, and there is a tendency that it becomes difficult to form flat films. When the films themselves have unevenness, the pressure drop of the filter unfavorably increases.

The average area of the cross sections of one cell vertical to the longitudinal direction of the cell plugged in the inflow end faces is preferably not more than that of the cross sections of the one cell vertical to the longitudinal direction of the cell plugged in the outflow end faces. FIG. 4 is a front view of the inflow end face of the honeycomb filter having such a cell structure. As the cell structure of the honeycomb filter, in order to improve an NOₓ reduction performance, the surface areas of the cells on an inlet side may be increased. Reasons for this are that the exhaust gas inflow side partition walls are coated with zeolite and that a probability of contact with an NOₓ gas increases. Moreover, as described in JP-A-2004-896, in consideration of the performance of the DPF, the pressure drop increases only little with an elapse of time during actual use, and hence the inlet side surface areas of the cells may be increased as described above.

When the honeycomb filter 1 is used, as shown by thick arrows in FIG. 2, an exhaust gas (a fluid) flows from one end face 2a side (from one end (the end on the end face 2a side) where the predetermined cells 3a open) into the cells 3 (the predetermined cells 3a), passes through the partition walls 4 as filter layers, is discharged as the passed fluid into the cells 3 (remaining cells 3b) opened on the side of the other end face 2b side, and is discharged from the side of the other end face 2b (the other ends of the remaining cells 3b (the ends on the end face 2b side)). When the exhaust gas passes through the partition walls 4, at least a part of a PM included in the exhaust gas is collected by the films 12 containing zeolite as the main component. In addition, NOₓ included in the exhaust gas is reduced by the films (the coat layers) 12 containing zeolite as the main component.

In the honeycomb filter 1, the partition walls 4 are arranged so as to form the plurality of cells 3 connecting the two end faces 2a, 2b, and the plugging portions 10 are arranged so as to plug the cells 3 in the end face 2a or 2b. The plugging portions 10 are present so that the adjacent cells 3 are plugged at opposite ends (the ends on the end face 2a, 2b sides), and consequently the end faces of the honeycomb filter 1 have a checkered pattern as shown in FIG. 1.

The outer peripheral wall 20 positioned at the outermost periphery of the honeycomb filter 1 (see FIG. 1) is preferably an integrally formed wall which is formed integrally with portions constituting the partition walls 4 during manufacturing (during formation), but it is also preferably a cement-coated wall which is obtained by grinding, into a predetermined shape, the outer periphery of the portions constituting the partition walls 4 after the formation and then forming the outer peripheral wall with a cement or the like. Moreover, in the honeycomb filter 1, the plugging portions 10 are arranged so as to plug the cells 3 in the end face 2a or 2b, but the honeycomb filter is not limited to such an arrangement state of the plugging portions, and the plugging portions may be arranged in the cells. Alternatively, the decrease of the pressure drop is given priority to a filter performance, and a configuration may be employed in which any plugging portion is not provided in a part of the cells.

The density (cell density) of the cells 3 of the honeycomb filter 1 is preferably 15 cells/cm² or more and less than 65 cells/cm², and the thicknesses of the partition walls 4 are preferably 200 μm or more and less than 600 μm. The pressure drop during the deposition of the PM is decreased, as a filter area is large. Therefore, when the cell density is high, the pressure drop during the deposition of the PM decreases. On the other hand, the initial pressure drop decreases, when the hydraulic diameters of the cells are decreased. From this viewpoint, the cell density is preferably small. When the thicknesses of the partition walls 4 are increased, a collection efficiency improves, but the initial pressure drop increases. When the tradeoff of the initial pressure drop, the pressure drop during the deposition of the PM and the collection efficiency are taken into consideration, the ranges of the cell density and partition wall thicknesses which satisfy all the conditions are the above ranges.

The thermal expansion coefficient of the honeycomb filter 1 in the connecting direction of the cells 3 at 40 to 800° C. is preferably less than 1.0×10⁻⁶/° C., further preferably less than 0.8×10⁻⁶/° C., especially preferably less than 0.5×10⁻⁶/° C. When the thermal expansion coefficient of the filter in the connecting direction of the cells at 40 to 800° C. is less than 1.0×10⁻⁶/° C., a heat stress generated during exposure to the exhaust gas having a high temperature can be suppressed in a tolerance range, and breakdown due to the heat stress can be prevented.

As shown in FIGS. 1 and 2, the whole shape of the honeycomb filter 1 is columnar (cylindrical), and the shapes of the cells 3 (the shapes of the cross sections of the cells vertical to the connecting direction of the cells 3, cut along the diametric direction of the honeycomb filter 1) are quadrangular, but there is not any special restriction on the whole shape of the honeycomb filter and the shapes of the cells. Examples of the whole shape include an elliptic columnar shape, an oblong columnar shape and polygonal shapes such as a quadrangular post-like shape and a triangular post-like shape, and examples of the cell shape include a hexagonal shape and a triangular shape.

(Films containing Zeolite as Main Component (Coat Layers))

Examples of the type of zeolite of the films (the coat layers) 12 containing zeolite as the main component include ZSM-5, β-zeolite, mordenite, ferrielite, A-type zeolite, X-type zeolite and Y-type zeolite. The films preferably contain ZSM-5 or β-zeolite.

The films 12 containing zeolite as the main component preferably contain at least one selected from the group consisting of titanium, vanadium, chromium, manganese, iron, cobalt, nickel, copper, rhodium, palladium, silver and platinum. It is known that zeolite itself has adsorption properties with respect to polar molecules of ammonia or the like and that NOₓ reduction properties improve by ion exchange between zeolite and cations of a transient metal such as titanium, vanadium, manganese, iron, cobalt, nickel or copper or a noble metal such as rhodium, palladium, silver or platinum (Non-Patent Documents 1 and 2).

The thickness of each of the coat layers 12 is preferably from 0.5 to 200% of the thickness of each of the partition walls (ribs) 4. If the thickness of the coat layer 12 is 0.5% or less, the PM enters the ribs, and the pressure drop during the deposition of the soot unfavorably increases. On the other hand, if the thickness is 200% or more, the PM is effectively prevented from entering the inside, but the strength of the film runs short, thereby unfavorably causing peels.

As to the pore properties of the coat layers 12, the pore diameters of the coat layers are preferably smaller than those of the partition walls 4 (here the median diameters measured by a mercury porosimeter). This behavior is shown in FIG. 3. FIG. 3 is a partially sectional view showing an enlarged part Q of FIG. 2 excluding the other part. As shown in FIG. 3, when the pore diameters of the coat layers 12 are smaller than those of the partition walls 4, a particle matter (PM) 7 is collected on the coat layers 12 and prevented from entering the partition walls 4. Specifically, the median diameters of the coat layers 12 are preferably 0.02 μm or more and 60 μm or less.

The porosities of the coat layers 12 are preferably equal to those of the partition walls 4. Specifically, the porosities of the coat layers 12 are preferably 30% or more and 60% or less. If the porosities are less than 30%, the densification of the films occurs, the smoothness of the film itself deteriorates, and the pressure drop tends to increase. On the other hand, if the porosities are larger than 60%, the films become more porous than the partition walls, the PM itself passes through the films to fill in the pores of the partition walls, and the pressure drop tends to increase. For these reasons, the above range of the porosities of the coat layers is preferable.

An SiO₂/Al₂O₃ ratio of zeolite constituting the films containing zeolite as the main component is preferably 1 or more and 500 or less. When the SiO₂/Al₂O₃ ratio is small, the performance of zeolite as a polar adsorber improves, and ammonia molecules are easily adsorbed, but the strength of the film itself lowers. On the other hand, when the SiO₂/Al₂O₃ ratio is large, the polar molecule adsorption effect lowers, but the strength improves. When such contradictory properties are taken into consideration, the above range is preferable.

In an NOₓ-DPF in which the porosity of a base material is low, robust properties are high. Moreover, when the pore diameters of the coat layers 12 are smaller than those of the partition walls (ribs) 4, the PM does not easily enter the partition walls 4. When the PM enters the partition walls (ribs) 4, the pressure drop increases. In the present invention, however, the partition walls 4 are coated with the coat layers 12, and hence the PM does not enter the partition walls 4. Therefore, an effect of decreasing the pressure drop during the deposition of the soot develops. Moreover, ammonia is easily adsorbed owing to the chemical characteristics of zeolite, and NOₓ can efficiently be reduced by the above SCR reaction.

(Manufacturing Method)

To obtain the honeycomb filter 1, a honeycomb structure is beforehand prepared as a fired article. The ends of the cells 3 are preferably plugged by the plugging portions 10 to prepare the plugged honeycomb structure before the honeycomb structure is provided with the coat layers 12. There is not any special restriction on means for obtaining the honeycomb structure (the plugged honeycomb structure). The honeycomb structure can be prepared by, for example, the following method.

First, the above example of the material of the partition walls is used as a raw material, and the material is mixed and kneaded to form a clay. When, for example, cordierite is used as the material of the partition walls, a dispersion medium such as water and a pore former are added to a cordierite forming material, and an organic binder and a dispersant are further added thereto and kneaded therewith to form a puddle-like clay. There is not any special restriction on means for kneading the cordierite forming material (a forming material) to prepare the clay, and examples of the means include methods in which a kneader, a vacuum clay kneader and the like are used.

The cordierite forming material means the material which becomes cordierite when fired, and is a ceramic material blended so as to have a chemical composition including 42 to 56 mass % of silica, 30 to 45 mass % of alumina and 12 to 16 mass % of magnesia. Specifically, the material includes a plurality of inorganic materials selected from the group consisting of talc, kaolin, calcinated kaolin, alumina, aluminum hydroxide and silica in the above ranges of the chemical composition. The pore former is preferably a material having properties that the material flies, scatters and disappears in a firing process, and an inorganic substance such as cokes, a polymeric compound such as a resin balloon, an organic substance such as starch or the like may be used alone or as a combination thereof. Examples of the organic binder include hydroxypropoxyl methylcellulose, methylcellulose, hydroxyethylcellylose, carboxyl methylcellulose and polyvinyl alcohol. These examples may be used alone or as a combination of two or more thereof. Examples of the dispersant include ethylene glycol, dextrin, fatty acid soap and polyalcohol. These examples may be used alone or as a combination of two or more thereof.

Next, the obtained clay is formed into a honeycomb shape to prepare a formed honeycomb article. There is not any special restriction on a method for preparing the formed honeycomb article, and a heretofore known forming method such as extrusion forming, injection forming or press forming may be used. Above all, a method for extruding the above prepared clay by use of a die having desired cell shape, partition wall thicknesses and cell density and the like is a preferable example.

Next, both ends of the obtained formed honeycomb article are plugged. There is not any special restriction on a plugging method. For example, a plugging slurry containing the cordierite forming material, water or alcohol and the organic binder is stored in a container, and the cells in one end face of the formed honeycomb article are alternately closed, whereby the end face of the article is masked in a checkered pattern. Next, the end of the article on the side of the masked end face thereof is immersed into the container, and the plugging slurry is charged into the cells which are not masked, to form plugging portions (the plugging portions 10). The other end of each cell having the one end plugged is masked, and the plugging portion is formed in the same manner as in the plugging portion formed in the one end. In consequence, the formed honeycomb article has a structure in which the other end of each cell having one end opened (non-plugged) is plugged and in which the one end and the other end of each cell are alternately closed in the checkered pattern.

Next, the formed and plugged honeycomb article was dried to prepare a dried honeycomb article. There is not any special restriction on drying means, and a heretofore known drying method such as hot air drying, microwave drying, dielectric drying, pressure reduction drying, vacuum drying or freeze drying may be used. Above all, a drying method in which the hot air drying is combined with the microwave drying or the dielectric drying is preferable, because the whole formed article can quickly and uniformly be dried.

Next, the obtained dried honeycomb article is calcinated to prepare a calcinated article before firing the article. The calcinating means an operation of burning and removing an organic substance (the organic binder, the dispersant, the pore former or the like) in the formed honeycomb article. In general, the burning temperature of the organic binder is from about 100 to 300° C., and the burning temperature of the pore former is from about 200 to 800° C., whereby a calcinating temperature may be from about 200 to 1000° C. There is not any special restriction on a calcinating time, but the time is usually from about 10 to 100 hours.

Next, the obtained calcinated article is fired to obtain the (plugged) honeycomb structure. In the present invention, the firing means an operation of sintering and densifying the forming material in the calcinated article to secure a predetermined strength. Firing conditions

(temperature•time) vary in accordance with the type of the forming material, and hence appropriate conditions may be selected in accordance with the type. The cordierite material is preferably fired at 1410 to 1440° C. Moreover, the material is preferably fired for about three to ten hours.

Next, zeolite is arbitrarily mixed with a metal in a wet system, dried, crushed, and mixed with silica sol or alumina sol and water to prepare a slurry. For example, copper is used in the form of copper acetate, and iron is used in the form of an ammine complex, whereby ion exchange can be performed in the pores of zeolite. The prepared slurry is sucked into the predetermined cells of the honeycomb structure obtained as described above, to coat the cells. After the coating, the slurry was dried at 600° C. to 700° C. for about four hours, thereby removing water. In this way, the coat layers containing zeolite are prepared. The formed zeolite coat layers do not enter the honeycomb structure, and the most outer surfaces are coated with the layers. As described above, it is possible to obtain a honeycomb filter in which the side wall surface layers of the predetermined cells of the honeycomb structure are coated with zeolite as described above.

### EXAMPLES

Hereinafter, the present invention will further specifically be described with respect to examples, but the present invention is not limited to these examples.

### Example 1

### Preparation of Plugged Honeycomb Filter

As cordierite forming materials, alumina, aluminum hydroxide, kaolin, talc and silica were used, and to 100 parts by mass of the cordierite forming materials, 13 parts by mass of pore former, 35 parts by mass of dispersion medium, 6 parts by mass of organic binder, and 0.5 part by mass of dispersant were added, respectively, followed by mixing and kneading, whereby a clay was prepared. Water was used as the dispersion medium, cokes having an average particle diameter of 10 μm were used as the pore former, hydroxypropyl methylcellulose was used as the organic binder, and ethylene glycol was used as the dispersant.

Next, the clay was extruded by using a predetermined die, to obtain a formed honeycomb article having a quadrangular cell shape, and the whole shape of the article was columnar (cylindrical). Then, the formed honeycomb article was dried by a microwave drier, and completely dried by a hot air drier. Afterward, both end faces of the formed honeycomb article were cut and regulated to predetermined dimensions.

Next, the open frontal areas of the cells in one end face of the formed honeycomb article were alternately masked in a checkered pattern, and the end of the article on the masked side was immersed into a plugging slurry containing the cordierite forming materials, to form plugging portions alternately arranged in the checkered pattern. In the other end of the article, the cells each having one end plugged were masked, and plugging portions were formed in the same manner as in the plugging portions formed in the one end of the article described above. Afterward, the formed honeycomb article provided with the plugging portions was dried by a hot air drier, and fired at 1410 to 1440° C. for five hours, to obtain the plugged honeycomb structure for a honeycomb filter.

The shape of each sample was a columnar shape with 140 mm in diameter×150 mm in length. In Table 1, a rib thickness is a partition wall thickness, mil means mili-inch length, and 1 mil=2.54 mm. In “a cell structure”, A indicates the average area of the cross sections of one cell vertical to the longitudinal direction of the cell plugged in the gas inflow side end face of a DPF. Moreover, B indicates the average area of the cross sections of the one cell vertical to the longitudinal direction of the cell plugged in the outflow end face of the DPF. In “the cell structure”, A:B indicates a ratio between these areas. The pore characteristics of partition walls and coat layers were measured by Auto Pore IV manufactured by Shimadzu Corporation. A median diameter means a 50% diameter when a pore distribution is integrated and displayed. The strengths of the partition walls mean strengths in a case where a sample having a columnar shape with one inch in a longitudinal direction in which a gas flowed and 1 inch in diameter in a direction vertical to a gas circulating direction was taken out, and compressed from the longitudinal direction.

Moreover, “a metal concentration” means the concentration of a metal contained in the slurry which coats a mother material. In the present example, all the concentrations were 3%.

### Example 1, Comparative Examples 1 to 3

Honeycomb structures made of cordierite and having porosities of 45% and 65% were prepared. A slurry containing 56% of ZSM-5 (SiO₂/Al₂O₃=36) zeolite, 4% of colloidal silica, 3% of copper acetate (Cu(CH₃COO)₂) and 37% of water was prepared, and the honeycomb structures were coated with the slurry by a suction system. After coating each of the structures with the zeolite containing slurry, the structure was dried at 90° C. for two hours, placed in an electric path, dried at 650° C. with a temperature rise speed of 200° C./hour for four hours, and then returned to room temperature at 400° C./h.

Moreover, for comparison, the samples having both the porosities were coated with a slurry containing γ-alumina and Pt (simulating a ternary catalyst), and treated at 650° C. Results are shown in Table 1.

TABLE 1

| | | | | Compar- | Compar- | Compar- | | | | | | | |
|---|---|---|---|---|---|---|---|---|---|---|---|---|---|
| | | | | ative | ative | ative | Exam- | Exam- | Exam- | Exam- | Exam- | Exam- | Exam- |
| | | | Example 1 | Example 1 | Example 2 | Example 3 | ple 2 | ple 3 | ple 4 | ple 5 | ple 6 | ple 7 | ple 8 |
| Mother | Material | | Cd | Cd | Cd | Cd | Cd | Cd | Cd | Cd | Cd | Cd | Cd |
| material | | | (cordi- | | | | | | | | | | |
| | | | erite) | | | | | | | | | | |
| | Rib thickness | mil | 12.0 | 12.0 | 12.0 | 12.0 | 12.0 | 5.9 | 9.8 | 12.0 | 12.0 | 12.0 | 12.0 |
| | Rib thickness | μm | 305 | 305 | 305 | 305 | 305 | 150 | 250 | 305 | 305 | 305 | 305 |
| | Cell structure | | 1:1 | 1:1 | 1:1 | 1:1 | 1:1.5 | 1:5 | 1:1.2 | 1:1.5 | 1:1.5 | 1:1.5 | 1:1.5 |
| | A:B⁽¹⁾ | | | | | | | | | | | | |
| | Porosity | % | 45 | 45 | 65 | 65 | 45 | 45 | 45 | 45 | 45 | 45 | 45 |
| | Median diameter | μm | 14 | 14 | 14 | 14 | 14 | 14 | 14 | 14 | 14 | 14 | 14 |
| | Compressive | MPa | 16 | 16 | 4 | 4 | 16 | 9 | 17 | 16 | 16 | 16 | 16 |
| | strength | | | | | | | | | | | | |
| Coat | Thickness of coat | μm | 30 | 30 | 30 | 30 | 30 | 30 | 30 | 1.5 | 15 | 155 | 600 |
| layer | layer | | | | | | | | | | | | |
| | Catalyst type | | ZSM-5 | γ-alumina | ZSM-5 | γ-alumina | ZSM-5 | ZSM-5 | ZSM-5 | ZSM-5 | ZSM-5 | ZSM-5 | ZSM-5 |
| | SiO₂/Al₂O₃ ratio | | 36 | — | 36 | — | 36 | 36 | 36 | 36 | 36 | 36 | 36 |
| | Ion exchange type | | Cu | Pt | Cu | Pt | Cu | Cu | Cu | Cu | Cu | Cu | Cu |
| | (loading metal for | | | | | | | | | | | | |
| | γ-alumina) | | | | | | | | | | | | |
| | Metal | % | 3 | 3 | 3 | 3 | 3 | 3 | 3 | 3 | 3 | 3 | 3 |
| | concentration | | | | | | | | | | | | |
| | Porosity of coat | % | 42 | 39 | 43 | 41 | 42 | 43 | 43 | 43 | 41 | 42 | 42 |
| | layer | | | | | | | | | | | | |
| | Median diameter | μm | 10 | 15 | 12 | 15 | 9 | 10 | 11 | 0.8 | 11 | 11 | 10 |
| | of coat layer | | | | | | | | | | | | |
| | Presence of | | None | None | Present | Present | None | None | None | None | None | None | None |
| | cracking | | | | | | | | | | | | |
| | during catalyst | | | | | | | | | | | | |
| | coating and heat | | | | | | | | | | | | |
| | treatment | | | | | | | | | | | | |
| | Light off | ° C. | 196 | 285 | — | — | 190 | 187 | 208 | 237 | 225 | 215 | 190 |
| | Temperature | | | | | | | | | | | | |
| | of NOₓ | | | | | | | | | | | | |

⁽¹⁾Meaning of A:B: A is the average area of the cross sections of one cell vertical to the longitudinal direction of the cell plugged in an inflow end face, and B is the average area of the cross sections of one cell vertical to the longitudinal direction of the cell plugged in an outflow end face.

When the honeycomb structure having a porosity of 65% was coated with both the zeolite slurry and the γ-alumina-based slurry, and heat-treated, the structure was cracked. It has been supposed that when the porosities of the partition walls are 65%, the compressive strength is also low, and hence the structure is cracked.

Moreover, to evaluate an NOₓ reduction performance, a gas containing 1% of NO₂ gas, 1% of ammonia and 98% of nitrogen gas was passed, and a temperature when NO₂ was reduced to a half was evaluated. In consequence, it has been confirmed that in the structure coated with zeolite (Example 1), NOₓ can be reduced at a lower temperature as compared with the structure coated with γ-alumina and Pt (Comparative Example 1) (refer to the column of Light off Temperature in Table 1).

(Effectiveness with Respect to Pressure Prop)

Results of the evaluation of the pressure drop during the deposition of soot are shown in FIG. 5. An (initial) pressure drop before the deposition of the soot was slightly high as compared with a structure which was not coated (bare), but the pressure drop during the deposition of the soot was eventually small (see FIG. 5). It has been supposed that in the bare structure, the soot enters the partition walls (the ribs), but in the structure coated with zeolite, the soot is deposited only on the surfaces of the ribs, and does not easily enter the ribs, and hence the pressure drop is small as compared with the bare structure.

### Examples 2 to 4

Next, the cell structure of a honeycomb structure (a mother material) was changed, to prepare the honeycomb structure having the cell structure in which the opening areas of cells on a gas inflow side were larger than those of cells on a gas outflow side, and the structure was coated with a zeolite layer. Results are shown in Table 1. In Table 1, A:B is shown, and A indicates the average area of the cross sections of one cell vertical to the longitudinal direction of the cell plugged in the gas inflow side end face of a DPF. Moreover, B indicates the average area of the cross sections of the one cell vertical to the longitudinal direction of the cell plugged in the outflow end face of the DPF. In Example 1, A:B was 1:1, but it has been found that when B in the ratio A:B is increased (i.e., the opening areas of the inlet-side cells are larger than those of the outlet-side cells), the light off temperature can further be lowered.

### Examples 5 to 8

The thickness of a zeolite coat layer was changed, when evaluation was performed. Results are shown in Table 1. While a partition wall rib thickness was 300 μm, the thickness of the coat layer was set to a thickness corresponding to 0.5% (1.5 μm) to 200% (600 μm). In Example 5, the coat layer was thin, and hence a light off temperature was higher than that of Example 1, but in all of Examples 5 to 8, the results were lower than those of Comparative Example 1, and the effect of the zeolite coating has been confirmed.

### Examples 9 to 11

Next, an SiO₂/Al₂O₃ ratio was changed, and a similar test was performed. Results are shown in Table 2.

Consequently, a light off temperature tended to lower, as the SiO₂/Al₂O₃ ratio was high, but eventually the light off temperature was lower than that of Comparative Example 1.

TABLE 2

| | | | | Exam- | Exam- | Exam- | Exam- | Exam- | Exam- | Exam- | Exam- | Exam- | Exam- | Exam- |
|---|---|---|---|---|---|---|---|---|---|---|---|---|---|---|
| | | | Exam- | ple | ple | ple | ple | ple | ple | ple | ple | ple | ple | ple |
| | | | ple 9 | 10 | 11 | 12 | 13 | 14 | 15 | 16 | 17 | 18 | 19 | 20 |
| Mother | Material | | Cd | Cd | Cd | Cd | Cd | Cd | Cd | Cd | Cd | Cd | SiC | AT |
| material | Rib thickness | mil | 12.0 | 12.0 | 12.0 | 12.0 | 12.0 | 12.0 | 12.0 | 12.4 | 11.2 | 11.0 | 12.0 | 11.9 |
| | Rib thickness | μm | 305 | 305 | 305 | 305 | 305 | 305 | 305 | 315 | 285 | 280 | 305 | 301 |
| | Cell structure | | 1:1.5 | 1:1.5 | 1:1.5 | 1:1.5 | 1:1.5 | 1:1.5 | 1:1.5 | 1:1.5 | 1:1.5 | 1:1.5 | 1:1.5 | 1:1.5 |
| | A:B⁽¹⁾ | | | | | | | | | | | | | |
| | Porosity | % | 45 | 45 | 45 | 45 | 45 | 45 | 45 | 59 | 58 | 31 | 49 | 48 |
| | Median diameter | μm | 14 | 14 | 14 | 14 | 14 | 14 | 14 | 58 | 23 | 3.5 | 17 | 18 |
| | Compressive | MPa | 16 | 16 | 16 | 16 | 16 | 16 | 16 | 7 | 10 | 18 | 23 | 18 |
| | strength | | | | | | | | | | | | | |
| Coat | Thickness of coat | μm | 30 | 30 | 30 | 20 | 30 | 30 | 30 | 30 | 30 | 30 | 30 | 30 |
| layer | layer | | | | | | | | | | | | | |
| | Catalyst type | | ZSM-5 | ZSM-5 | ZSM-5 | β- | ZSM-5 | ZSM-5 | ZSM-5 | ZSM-5 | ZSM-5 | ZSM-5 | ZSM-5 | ZSM-5 |
| | | | | | | zeolite | | | | | | | | |
| | SiO₂/Al₂O₃ ratio | | 1.9 | 270 | 500 | 20 | 36 | 36 | 36 | 36 | 36 | 36 | 36 | 36 |
| | Ion exchange type | | Cu | Cu | Cu | Cu | Fe | Ni | Fe, Cu | Cu | Cu | Cu | Cu | Cu |
| | (loading metal for | | | | | | | | | | | | | |
| | γ-alumina) | | | | | | | | | | | | | |
| | Metal | % | 3 | 3 | 3 | 3 | 3 | 3 | 1.5, 1.5 | 3 | 3 | 3 | 3 | 3 |
| | concentration | | | | | | | | | | | | | |
| | Porosity of coat | % | 43 | 42 | 42 | 33 | 40 | 44 | 38 | 58 | 56 | 30 | 39 | 41 |
| | layer | | | | | | | | | | | | | |
| | Median diameter | μm | 13 | 11 | 10 | 7 | 10 | 9 | 6 | 57 | 20 | 0.02 | 10 | 11 |
| | of coat layer | | | | | | | | | | | | | |
| | Presence of | | None | None | None | None | None | None | None | None | None | None | None | None |
| | cracking | | | | | | | | | | | | | |
| | during catalyst | | | | | | | | | | | | | |
| | coating and heat | | | | | | | | | | | | | |
| | treatment | | | | | | | | | | | | | |
| | Light off | ° C. | 185 | 230 | 252 | 238 | 195 | 216 | 193 | 199 | 202 | 205 | 212 | 204 |
| | Temperature | | | | | | | | | | | | | |
| | of NOₓ | | | | | | | | | | | | | |

⁽¹⁾Meaning of A:B: A is the average area of the cross sections of one cell vertical to the longitudinal direction of the cell plugged in the inflow end face, and B is the average area of the cross sections of one cell vertical to the longitudinal direction of the cell plugged in the outflow end face.

### Example 12

The type of zeolite was changed from ZSM-5 to β-zeolite. Results are shown in Table 2. It has been seen that a light off temperature is lower than that of Comparative Example 1 and that this example is effective for NOₓ reduction.

### Examples 13 to 15

The type of a metal to be added was changed. Results are shown in Table 2. To zeolite, iron, nickel, as well as iron and copper were added. As to iron, an aqueous solution containing 56% of zeolite ZSM-5, 4% of colloidal silica, 3% of complex material [Fe(CO)₄]²⁻ and 37% of water was prepared, and a mother material was coated with this solution. Moreover, as to nickel, a slurry was prepared by using complex ions in the same manner as in iron, and the mother material was coated with the slurry. Furthermore, a slurry containing 1.5% of each of iron and copper was prepared by using copper acetate and complex ions of iron, and the mother material was coated with this slurry. Consequently, it has been seen that a light off temperature is lower than that of Comparative Example 1 using a ternary catalyst and that these examples are effective for NOₓ reduction.

### Examples 16 to 18

Next, the pore characteristics of partition walls of a mother material were changed. Moreover, the median diameters of coat layers were set to be smaller than those of the partition walls of the mother material so that the pores of the partition walls of the mother material were not filled with a PM. Results are shown in Table 2. As a result of the evaluation of NOₓ reduction properties, it has been seen that a light off temperature is lower than that of Comparative Example 1 and that these examples are effective for NOₓ reduction. Moreover, when the porosities of the partition walls of the mother material were 60% or less in Examples 16 and 17, cracking due to a heat treatment did not occur. Thus, it has been seen that the porosities of the partition walls of the mother material are preferably 60% or less.

### Examples 19 and 20

A mother material was changed to SiC and an AT material. Results are shown in Table 2. These examples have different mother materials, and hence cannot simply be compared with the examples made of Cd. However, it has been seen that a light off temperature is low and that these examples are effective for NOₓ reduction.

The honeycomb filter according to the present invention can be used to remove, from an exhaust gas, a particle matter in the exhaust gas discharged from an internal combustion engine such as an engine for a car, an engine for a construction machine or a stational engine for an industrial machine, or another combustion apparatus.

### DESCRIPTION OF REFERENCE NUMERALS

1: honeycomb filter, 2a, 2b: end face, 3: cell, 3a: predetermined cell, 3b: remaining cell, 4: partition wall, 7: particle matter (PM), 10: plugging portion, 12: film (coat layer) containing zeolite as main component, and 20: outer peripheral wall.

What is claimed is:

1. A honeycomb filter comprising: porous partition walls which partition a plurality of cells as through channels for a fluid; predetermined cells each having one end opened and the other end plugged; and the remaining cells each having one end plugged and the other end opened, the predetermined cells and the remaining cells being alternately arranged,
wherein surface layers of the partition walls on the side of the predetermined cells are coated with films containing zeolite as a main component.

2. The honeycomb filter according to claim 1, wherein the partition walls contain at least one selected from the group consisting of cordierite (Cd), SiC and aluminum titanate (AT).

3. The honeycomb filter according to claim 1, wherein the partition walls have median diameters of 3 μm or more and 60 μm or less and porosities of 30% or more and 60% or less.

4. The honeycomb filter according to claim 1, wherein the average area of the cross sections of one cell vertical to the longitudinal direction of the cell plugged in the inflow end faces is not more than that of the cross sections of the cell vertical to the longitudinal direction of the cell plugged in the outflow end faces.

5. The honeycomb filter according to claim 1, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

6. The honeycomb filter according to claim 1, wherein the thicknesses of the films containing zeolite as the main component are 0.5% or more and 200% or less of those of the partition walls.

7. The honeycomb filter according to claim 1, wherein zeolite of the films containing zeolite as the main component contains at least one selected from the group consisting of ZSM-5, β-zeolite, mordenite, ferrielite, A-type zeolite, X-type zeolite and Y-type zeolite.

8. The honeycomb filter according to claim 1, wherein an SiO₂/Al₂O₃ ratio of zeolite constituting the films containing zeolite as the main component is 1 or more and 500 or less.

9. The honeycomb filter according to claim 1, wherein the films containing zeolite as the main component contain at least one selected from the group consisting of titanium, vanadium, chromium, manganese, iron, cobalt, nickel, copper, rhodium, palladium, silver and platinum.

10. The honeycomb filter according to claim 2, wherein the partition walls have median diameters of 3 μm or more and 60 μm or less and porosities of 30% or more and 60% or less.

11. The honeycomb filter according to claim 2, wherein the average area of the cross sections of one cell vertical to the longitudinal direction of the cell plugged in the inflow end faces is not more than that of the cross sections of the cell vertical to the longitudinal direction of the cell plugged in the outflow end faces.

12. The honeycomb filter according to claim 3, wherein the average area of the cross sections of one cell vertical to the longitudinal direction of the cell plugged in the inflow end faces is not more than that of the cross sections of the cell vertical to the longitudinal direction of the cell plugged in the outflow end faces.

13. The honeycomb filter according to claim 10, wherein the average area of the cross sections of one cell vertical to the longitudinal direction of the cell plugged in the inflow end faces is not more than that of the cross sections of the cell vertical to the longitudinal direction of the cell plugged in the outflow end faces.

14. The honeycomb filter according to claim 2, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

15. The honeycomb filter according to claim 3, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

16. The honeycomb filter according to claim 4, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

17. The honeycomb filter according to claim 10, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

18. The honeycomb filter according to claim 11, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

19. The honeycomb filter according to claim 12, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.

20. The honeycomb filter according to claim 13, wherein the films containing zeolite as the main component have median diameters of 0.02 μm or more and 60 μm or less and porosities of 30% or more and 60% or less, and the median diameter of the partition walls is larger than the median diameters of the films containing zeolite as the main component.
